(19) United States
(12) Patent Application Publication
(10) Pub. No.: US 2023/0349751 A1
(43) Pub. Date: Nov. 2, 2023

(54) DEVICE AND METHOD FOR DISTRIBUTED SENSING IN A STAR NETWORK

(71) Applicant: OMNISENS S.A., Morges (CH)

(72) Inventors: Etienne ROCHAT, Valeyres Sous Ursins (CH); Alexandre Sydney Robert GOY, Cuarny (CH)

(21) Appl. No.: 18/305,286

(22) Filed: Apr. 21, 2023

(30) Foreign Application Priority Data
May 2, 2022 (EP) 22171178.1

(51) Int. Cl. G01K 11/322; G01H 9/00; G01K 11/324; H04B 10/071; G01D 5/353

(52) U.S. Cl. CPC G01H 9/004; G01D 5/35364; G01K 11/322; G01K 11/324; H04B 10/071

(57) ABSTRACT

The disclosure concerns a device (101) for distributed sensing comprising: a pump generator (1) for generating an optical pump signal, a pump splitter (2) configured to split the pump signal in a number N of channels (3), each channel comprising an optical fiber (31) or a connector (32) arranged for connecting an optical fiber, a controller configured to control the pump splitter, an optical receiver (4) for receiving a backscattered signal from the optical fiber or from the connector of each channel. The pump splitter comprises a gating system comprising a gate (21) for each channel among the N channels. Each gate is associated to a given channel and has an open state allowing the pump signal to go from the pump generator to the optical fiber or the connector of the associated channel, and a closed state for which the pump signal cannot go from the pump generator to the optical fiber or the connector of the associated channel.

### TECHNICAL FIELD

The present disclosure relates to device and method for distributed sensing.

The disclosure relates to distributed or fully distributed sensors, in which an optical fiber is a long uninterrupted sensor, and the measured information are extracted from the analysis of backscattered light.

### STATE OF THE ART

Most of the assets measured or monitored using DFOS (Distributed Fibre Optic Sensing) are linear. This is the case for power cable, for oil and gas pipeline, likewise for water pipeline. In such linear system, the limit is the maximum measurement range.

There are some structures that are similar to star network configuration rather than linear configuration. These are for instance the inter-array cable (IAC) inside windfarm or the gathering lines for the pipeline industry or the fibre-based telecommunication network (point-to-multipoint fiber-to-the-home (FTTH) network, also defined as a PON network) or lines in water / gas/ distribution pipelines or in sewage.

Monitoring of such a star network is difficult.

One possibility is to use multiple channels that are measured one after the other, in sequence. This is only possible when the targeted events have a slow time constant with respect to the sequence. For example, measuring temperature with a Distributed Temperature Sensing (DTS) is compatible with a sequence/channel-based approach. Assuming 10 channels and 3 min to measure one channel, then every channel is measured twice per hour. Given that the time constant of an IAC on thermal variation is in the 3h to 5h range, there is still a good coverage of the temperature.

This is not the case when looking at short event like anchor drop and short circuit. A short circuit may last for a few 10s of milliseconds. In other words, when using a 5 min measurement and 30 min sequence, most of the short circuits will not be detected, as they will appear in the non-measured channel. In this case, a sequence/channel-based approach is not possible.

One could:
use one Distributed Acoustic Sensing (DAS) sensor for each channel, but this solution is very expensive,
use one DAS sensor for several channels, by means of a very fast optical switch, such like in patent EP3172533B1, but this kind of solution is still technically complex and/or expansive, due to backreflection from switch and the need for perfect synchronization between pulse and switches.

### SUMMARY OF THE DISCLOSURE

The disclosure presents a device and/or method for distributed sensing, e.g., arranged for a star network, that is less complex and/or less expensive than prior art but with similar or better performances.

An aspect of the disclosure concerns a device for distributed sensing comprising:
a pump generator arranged for generating an (in some implementations pulsed) optical pump signal,
An optical pump splitter configured to receive the pump signal and to split the pump signal in a number N of channels, each channel comprising an optical fiber or a connector arranged for connecting an optical fiber,
A controller configured to control the pump splitter,
An optical receiver arranged for receiving a backscattered signal from the optical fiber or from the connector of each channel,
characterized in that:
the optical pump splitter comprises a gating system comprising a gate for each channel among the N channels, each gate associated to a given channel being arranged for having:
   ◯ an open state allowing the pump signal to go from the pump generator to the optical fiber or the connector of the associated channel, and
   ◯ a closed state for which the pump signal cannot go from the pump generator to the optical fiber or the connector of the associated channel.

The pump signal is, in some implementations, a pulsed pump signal, and the controller is, in some implementations, configured (e.g., arranged and/or programmed) to control so that each gate is, in some implementations, one after the other, in its open state a longer time than the duration of the pulsed pump signal in order to allow the pulsed pump signal to fully pass or go through the gate in its open state.

The controller can be configured (e.g., arranged and/or programmed) in order to avoid injecting the pump signal in at least two channels at the same time.

The optical receiver can comprise, for each channel, a circulator, arranged for:
directing the pump signal from the gate of this channel in its open state to the optical fiber or the connector of this channel but not to the optical receiver
directing the backscattered signal from the optical fiber or the connector of this channel to the optical receiver but not to the gate of this channel.

The backscattered signal can comprise a Rayleigh backscattered signal, a Brillouin backscattered signal, or a Raman backscattered signal.

Each channel can comprise an optical fiber monitoring a cable, pipe, branch or string of a star network, in some implementations, monitoring an inter array cable of a star network of a wind farm.

At least one of the channels can be arranged for monitoring several cables, pipes, branches and/or strings departing in several different directions from a central position of the star network, the optical fiber of this at least one channel going back and forth with respect to the central position.

Each channel can comprise an optical fiber monitoring at least one cable, pipe, branch and/or string of at least one among a pipeline network, a transport network such like a road or rail network, a telecommunication network, an information network, or an electrical network.

The optical receiver can comprise a detector shared for all the channels.

The controller can be configured (e.g., arranged and/or programmed) in order to allow at least two gates to be in the open state at the same time.

An aspect of the disclosure concerns a wind farm comprising a device according to the disclosure.

An aspect of the disclosure concerns a method for distributed sensing comprising:
generating, by a pump generator, an (e.g., pulsed) optical pump signal,
splitting, by an optical pump splitter, the pump signal in a number N of channels, each channel comprising an optical fiber or a connector arranged for connecting an optical fiber,
receiving, by an optical receiver, a backscattered signal from the optical fiber or from the connector of each channel,
characterized in that:
the splitting step is implemented with a gating system comprising a gate for each channel among the N channels, each gate associated to a given channel having:
   ◯ an open state allowing the pump signal to go from the pump generator to the optical fiber or the connector of the associated channel, and
   ◯ a closed state for which the pump signal cannot go from the pump generator to the optical fiber or the connector of the associated channel.

The pump signal is in some implementations a pulsed pump signal, and each gate is in some implementations, in some implementations one after the other, in its open state a longer time than the duration of the pulsed pump signal in order to allow the pulsed pump signal to fully pass or go through the gate in its open state.

The splitting step can avoid injecting the pump signal in at least two channels at the same time.

The optical receiver can comprise, for each channel, a circulator:
directing the pump signal from the gate of this channel in its open state to the optical fiber or the connector of this channel but not to the optical receiver
directing the backscattered signal from the optical fiber or the connector of this channel to the optical receiver but not to the gate of this channel.

The backscattered signal can comprise a Rayleigh backscattered signal, a Brillouin backscattered signal, or a Raman backscattered signal.

Each channel can comprise an optical fiber monitoring a cable, pipe, branch or string of a star network, in some implementations, monitoring an inter array cable of a star network of a wind farm.

At least one of the channels can be monitoring several cables, pipes, branches and/or strings departing in several different directions from a central position of the star network, the optical fiber of this at least one channel going back and forth with respect to the central position.

Each channel can comprise an optical fiber monitoring at least one cable, pipe, branch and/or string of at least one among a pipeline network, a transport network such like a road or rail network, a telecommunication network, an information network, or an electrical network.

The optical receiver can comprise a detector shared for all the channels.

The splitting step can allow at least two gates to be in the open state at the same time.

The method according to the disclosure can be used for monitoring a wind farm.

### BRIEF DESCRIPTION OF THE FIGURES

Other advantages and characteristics of the disclosure will appear upon examination of the detailed description of embodiments which are in no way limitative, and of the appended drawings in which:

FIG. 1 is a schematic view of a first embodiment 101 of a device according to the disclosure,

FIG. 2 shows, as a function of time, the generation or emission of the pulsed pump 5, the states of the gates 21, and the detected backscattered signal 6, in device 101

FIG. 3 is a schematic view of a second embodiment 102 of a device according to the disclosure,

FIG. 4 shows, as a function of time, the generation or emission of the pulsed pump 5, the states of the gates 21 and 11, and the detected backscattered signal 6, in device 102

FIG. 5 is an organigram of few steps of an embodiment of a method according to the disclosure implemented in device 101 or 102.

### DETAILED DESCRIPTION

These embodiments described herein being in no way limitative, we can consider variants of the disclosure including only a selection of characteristics subsequently described or illustrated, isolated from other described or illustrated characteristics (even if this selection is taken from a sentence containing these other characteristics), if this selection of characteristics is sufficient to give a technical advantage or to distinguish the disclosure over the state of the art. This selection includes at least one characteristic, in some implementations, a functional characteristic without structural details, or with only a part of the structural details.

The disclosure relates to distributed or fully distributed sensors, in which an optical fiber is a long uninterrupted sensor, and the measured information are extracted from the analysis of backscattered light.

The backscattered light can typically come from the following scatterings:
Rayleigh scattering, which is the interaction of a light pulse with material impurities (a typical example would be the scattering of sunlight by dust particles in the atmosphere giving to the sky different colors depending on the incident angle of the sun light). It is the largest of the three backscattered signals in silica fibers and has the same wavelength as the incident light. Rayleigh scattering is the physical principle behind Optical Time Domain Reflectometer (OTDR).
Brillouin scattering, which is the interaction of a light pulse with thermally excited acoustic waves (also called acoustic phonons). Acoustic waves, through the elasto-optic effect, slightly and locally modify the index of refraction. The corresponding moving grating reflects back a small amount of the incident light and shifts its frequency (or wavelength) due to the Doppler Effect. The shift depends on the acoustic velocity in the fiber while its sign depends on the propagation direction of the travelling acoustic waves. Thus, Brillouin backscattering is created at two different frequencies around the incident light, called the Stokes and the Anti-Stokes components. In silica fibers, the Brillouin frequency shift is in the 10 GHz range (0.1 nm in the 1550 nm wavelength range) and is temperature and strain dependent.
Raman scattering, which is the interaction of a light pulse with thermally excited atomic or molecular vibrations (optical phonons) and is the smallest of the three backscattered signals in intensity. Raman scattering exhibits a large frequency shift of typically 13 THz in silica fibers, corresponding to 100 nm at a wavelength of 1550 nm. The Raman Anti-Stokes component intensity is temperature dependent whereas the Stokes component is nearly temperature insensitive.

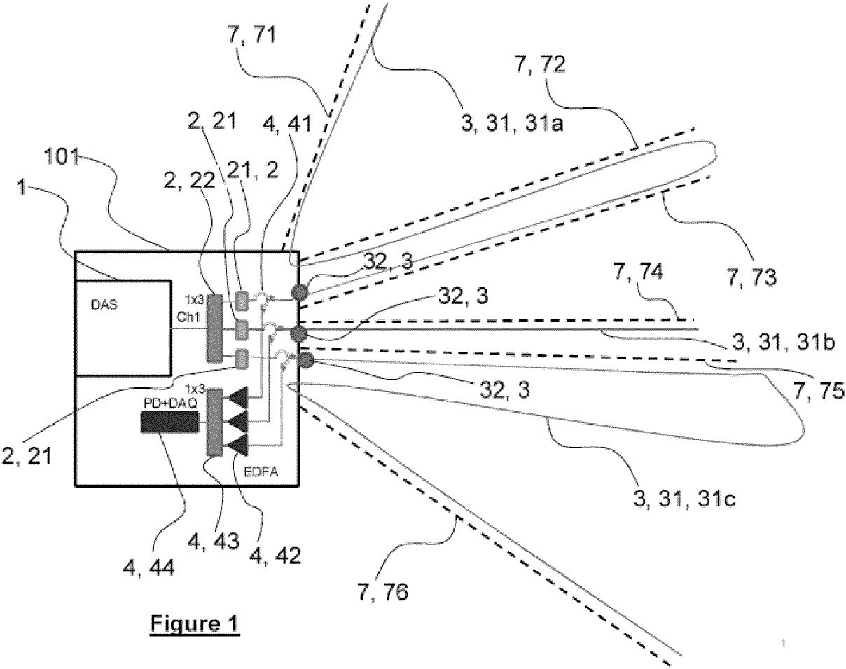

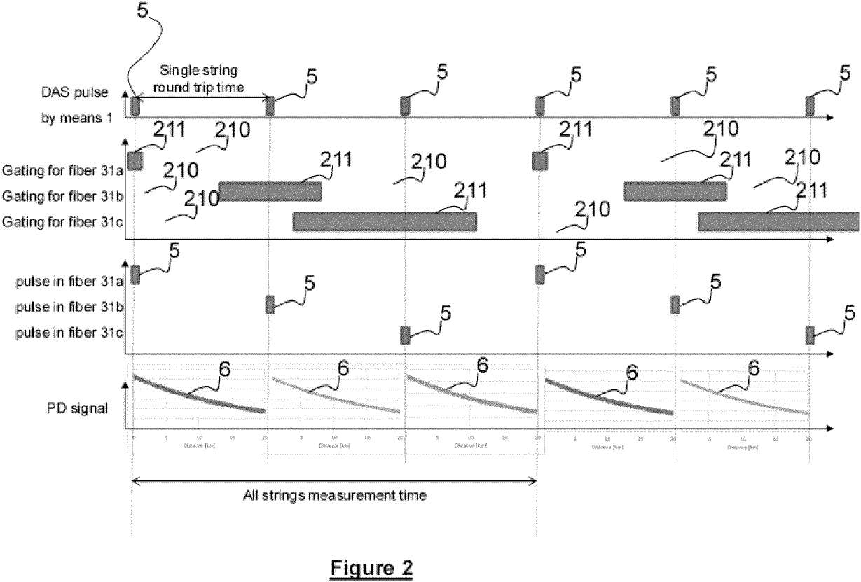

We are now going to describe, in references to FIGS. 1 and 2, the first embodiment of a device 101 according to the disclosure.

Device 101 for distributed sensing comprises a pump generator 1 arranged for generating a pulsed optical pump signal 5.

“Pulsed” optical signal 5 means a pulse regardless of its duration, for example short duration (of the order of a picosecond or femtosecond) or long duration (of the order of a few minutes or longer) or intermediate duration.

Pulse 5 duration is typically from one picosecond to 10 microseconds.

Pump generator 1 comprises typically a laser or a light-emitting diode, arranged for generating or emitting signal 5:
having a wavelength comprised between 1520 and 1560 nm, and/or
having a power comprised between 1 and 500 mW before being split by an optical pump splitter 2, and/or
having a duration between 10 ns and 300 ns.

However other kind of pump generator 1 may be employed within the scope of this disclosure.

Device 101 comprises the optical pump splitter 2 configured to receive the pump signal 5 and split the pump signal 5 in a number N of channels 3 (N being an integer greater than or equal to 2), each channel 3 comprising an optical fiber 31 and/or a connector 32 arranged for connecting an optical fiber 31.

Each connector 32 can also be called “pump connector” 32 as it is arranged and used to connect one of the fibers 31 to the pump generator 1.

Each fiber 31 is typically:
monomode in case of Brillouin or Rayleigh backscattered signal 6, or
monomode or multimode in case of Raman backscattered signal 6 and can be a single optical fiber or can comprise a fiber bundle (typically comprising few tens of individual fibers).

Connector 32 comprise a standard connector for optical fiber 31 or other suitable connection means.

The optical pump splitter 2 comprises:
an optical coupler 22, arranged for dividing the pulse 5 from pump generator 1 into one pulse 5 for each channel 3;
a gating system comprising a gate 21 for each channel 3 among the N channels, each gate 21 associated to a given channel 3 being arranged for having:
   ◯ an open state 211 allowing the pump signal 5 to go from the pump generator 1 to the optical fiber 31 or to the connector 32 of the associated channel 3, and
   ◯ a closed state 210 for which the pump signal 5 cannot go from the pump generator 1 to the optical fiber 31 or to the connector 32 of the associated channel 3.

Each gate 21 can also be called “pump gate” 21 as it is arranged and used to control if the pump signal 5 enters into one of the fibers 31 or not.

Each gate 21 could be home designed using:
a semi-conductor optical amplifier (SOA) and an electrical control signal, or
a shutter and an electrical control signal.

The pump signal is a pulsed signal, and each gate 21 is (e.g., one after the other) in its open state a longer time than the duration of the pulsed pump signal 5 in order to allow the pulsed pump signal to fully pass or go through the only one gate in its open state while the pump signal 5 reaches the gates 21.

Device 101 comprises a controller (not illustrated) configured to control the optical pump splitter 2. The controller can include at least one computer, one central processing or computing unit, one analogue electronic circuit (e.g., dedicated), one digital electronic circuit (e.g., dedicated) and/or one microprocessor (e.g., dedicated) and/or software means or other control means known in the art for controlling the optical pump splitter 2.

Device 101 comprises an optical receiver 4 arranged for receiving a backscattered signal 6 from the optical fiber 31 or from the connector 32 of each channel 3, this backscattered signal 6 being generated in fiber 31 in response to the pump signal 5.

As illustrated in FIG. 1, the optical fiber 31 of each channel 3 is arranged for monitoring a cable or pipe 7 (also referenced 71 to 76, and also called branch or string) of a star network, in some implementations, monitoring an inter array cable of a star network of a wind farm.

More precisely, each channel 3 comprises an optical fiber 31 monitoring at least one cable of a pipeline network, a transport network such like a road or rail network, a telecommunication network, an information network, or an electrical network.

The proposed solution of device 101 is thus a time-division multiplexing of the pump signal 5. In this way, each branch (cable or pipe) 7 can be covered by a single fiber 31 providing also a better signal quality.

At least one channel 3 is arranged for monitoring several branches 7 departing in several different directions from a central position of the star network; this at least one channel 3 going back and forth several times with respect to the central position. For example:
Channel 3 comprising optical fiber 31a is arranged for monitoring several cables or pipes 71, 72, 73 departing in several different directions from a central position of the star network, the optical fiber 31a of this channel 3 going back and forth with respect to the central position, each outward path and/or each return path of fiber 31a monitoring one of the cables or pipes 71, 72, 73
Channel comprising optical fiber 31c is arranged for monitoring several cables or pipes 75, 76 departing in several different directions from a central position of the star network, the optical fiber 31c of this channel 3 going back and forth with respect to the central position, each outward path and/or each return path of fiber 31c monitoring one of the cables or pipes 75, 76

Thus, for short event measurement and/or simultaneous measurement, it is possible to design the sensing path of fiber 31 by following one branch (cable or pipe) 7 to the end (following what is known as a string in the windfarm jargon) and come back to the device 101 (i.e. to the central position of the star network, known as the offshore substation in the windfarm jargon) before going to the next branch 7, as illustrated in FIG. 1.

In case of fiber 31c, the return path is useless. Assuming that each branch 7 is 10 km long and the range of the Distributed Acoustic Sensing (DAS) device 101 is 50 km, then it is possible to measure three strings 7 only per fiber 31, with two return paths, each of 10 km (10 km sensing - 10 km return - 10 km sensing - 10 km return - 10 km sensing). In this specific example of fiber 31c, 40% of the fiber length is not employed for active measurement (the return paths).

As illustrated by fiber 31a in FIG. 1, some strings 7 (72 and 73) may be connected by a fiber 31a at the far end. In this case the full measurement range can be used.

As illustrated in FIG. 2, the controller is configured (e.g., arranged and/or programmed) in order to avoid injecting the pump signal 5 in at least two channels 3 at the same time.

Pump generator 1 is arranged for generating pulse 5 several times, in some implementations at a temporal period Tₚ.

The controller is arranged in such a way that, each time pulse 5 is generated, this pulse 5 is split by the optical pump splitter 2 and reach each gate 21 of each channel 3, but only one of this gate 21 is in its open state 211, the other ones are in the closed state 210.

The controller is arranged in such a way that the gates 21 are in their open state 211 one after the other, and in such a way that, for a temporal period T_{N} comprising N generated pulses 5 for N gates of N channels 3, pulse number I (i is an integer equal to 1 to N), reaches all the gates 21 but only gate 21 number i of channel 3 number i is in its open state. This way, during a temporal period T_{N} (T_{N} = N × T_{P}), every fiber 31 of every channel 3 receives one by one pulse 5, one after the other.

Also, as illustrated by FIG. 2, the controller is configured (e.g., arranged and/or programmed) in order to optionally allow at least two gates 21 to be in the open state 211 at the same time, as long as they are not open at the same time when pulse 5 is reaching these at least two gates 21.

This perfectly illustrates technical advantages of device 101 according to the disclosure, compared to prior art (especially compared to a prior art solution using a very fast optical switch):
device 101 is less complex and less expensive, as a very precise synchronization between pulse 5 and a control of the gates 21 is not necessary, because at least two gates 21 can be open at the same time, or not, as long as they are not open at the same time when pulse 5 is reaching these at least two gates 21,
device 101 avoids backreflection from a switch,
device 101 can even be faster compared to prior art, because a second gate 21 can be ready in its open state before the previous gate 21 goes from its open state 211 to its closed state 210 (on the contrary, a switch cannot be “open” for two channels at the same time, and a switching time between two channels is necessary).

The fiber 31 reached by signal 5 is generating a backscaterred signal 6.

The backscattered signal 6 comprises a Rayleigh backscattered signal, a Brillouin backscattered signal, or a Raman backscattered signal. In case of FIGS. 1 and 2, the backscattered signal 6 comprises a Rayleigh backscattered signal, a Brillouin backscattered signal (without use of a probe signal for stimulating this Brillouin backscattered signal), or a Raman backscattered signal.

The optical receiver 4 typically comprises, for each channel 3, a circulator 41.

For each channel 3, the circulator 41 of this channel 3 is arranged for:
directing the pump signal 5 from the gate 21 of this channel 3 in its open state 211 to the optical fiber 31 or the connector 32 of this channel 3 but not to the optical receiver 4
directing the backscattered signal 6 from the optical fiber 31 or the connector 32 of this channel 3 to the optical receiver 4 but not to the gate 21 of this channel 3.

The optical receiver 4 typically also comprises:
for each channel 3, an optical amplifier 42, in some implementations, an Erbium-Doped Fiber Amplifier (EDFA), arranged for amplifying each signal 6 coming from the fiber 31 of this channel 3, in some implementations, coming from the circulator 41 of this channel 3,
an optical coupler 43 shared for all the channels 3, and arranged for coupling all the channels 3 (from the circulator 41 and/or amplifier 42 of the considered channel 3) to a detector 44
the detector 44 (comprising typically a photodiode PD and a data acquisition system DAQ) shared for all the channels 3.

It is also possible to have a single EDFA (not illustrated) at the exit of the 3×1 coupler 43 (rather than having three EDFA on each input of the 3×1 coupler 43). Having the 3×1 coupler first is possible for short string only. The EDFA after is thus limited to a small channel number (reasonably up to 4) and short range.

The data or signal 6 acquired by optical receiver 4 or detector 44 is then analyzed according to the classical design of the interrogator, the controller being configured (e.g., arranged and/or programmed) to know, depending on time, from which channel 3 is coming signal 6, based on the channel 3 that most recently received the pulse 5.

The analysis is backscattering dependent, typically:
for Distributed Acoustic Sensing (DAS): recovery of intensity and phase of the backscattering
for Distributed Temperature Sensing (DTS)-Brillouin or Distributed Strain Sensing (DSS)-Brillouin: recovery of the frequency shift
for Distributed Temperature Sensing (DTS)-Raman: recovery of the intensity.

Thus, in device 101, the pump signal 5 is split in N (assuming N channels 3, practically N equal three or four). But as such, the N channels 3 are synchronized (they receive the pump 5 simultaneously) and measurement by optical receiver 4 is done from each channel 3.

To maintain a “in series” measurement, the pump 5 is triggered at the max speed corresponding to the length L of the channel 3 (assuming for simplicity that the N channels 3 have an identical length L), which is N times faster than what is allowed for all the channels and a gating system let one pump 5 out of N go through to the relevant channel 3.

Detection is done easily as all channels 3 receive the pump 5 in series and a single acquisition can be done.

Let’s assume three channels 3 of 25 km each, for a total length of 75 km. The pulse rate would be 1.33 kHz max. Here, the pulse 5 is repeated at three times the pulse rate (4 kHz), with pulses i going to the first channel, pulse i+1 going to the second channel 3 and pulse i+2 going to the third channel 3 in cycles, so that each channel 3 receives pulses at 1.33 kHz in the proper timing. Performances are those of 25 km in term of signal quality, since each pump 5 travels 25 km only instead of 75 km, with the frequency bandwidth equivalent to 75 km (1.33 kHz/2 to take into account sampling theory) because of the total measuring time.

Device 101 is directly compatible with any single-based measurement system (like Raman Distributed Temperature Sensing (DTS) for instance) and is not limited to a particular type of Distributed Acoustic Sensing (DAS) interrogator. In fact, it is applicable to all fiber sensing devices working with a single fiber.

Device 101 is directly compatible with a Brillouin Optical Time Domain Reflectometry (BOTDR) (temperature or strain).

It is also noted the following various advantages of device 101:
each channel 3 has its own pump 5,
the measurement is in series, and is thus simple and efficient
range is not limited by folding (no range loss)
by using a gate 21 and a circulator 41 per sensing fiber 31 with a coupler 22, there is no need for a switch with its driver (simplification) and there is no need for accurate synchronization between switches and pulses. Slow gating (no need for short transition time and fast electronic) can be used as there is “plenty” of time between pulses 5
there is no cross talk between channels 3, as this is guaranteed by the pulse timing (no risk of overlap) and no backreflection from switching.

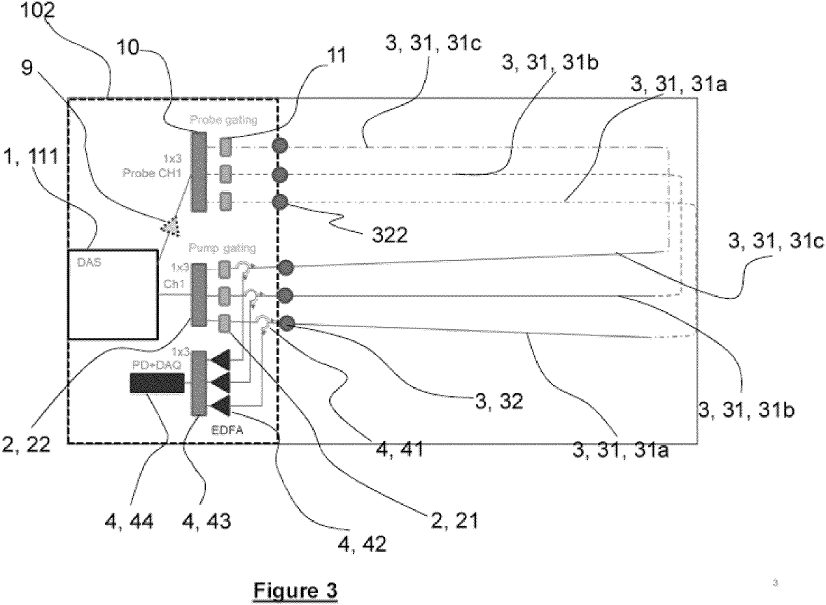

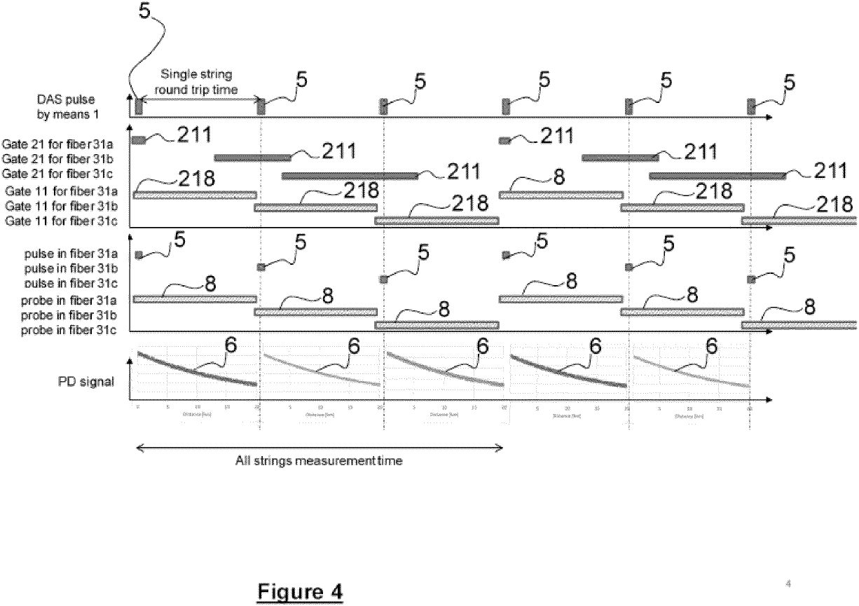

We are now going to describe, in references to FIGS. 3 and 4, a second embodiment of a device 102 according to the disclosure.

Device 102 will be described only for its differences compared to device 101.

In case of FIGS. 3 and 4, the backscattered signal 6 comprises a Brillouin backscattered signal, with use of a probe signal 8 for stimulating this Brillouin backscattered signal 6.

As illustrated by FIG. 3, device 102 according to the disclosure is directly compatible with a Brillouin Optical Time Domain Reflectometer (BOTDA) (loop configuration) by simply splitting the probe 8 in N (three in this case of FIG. 3) and looping on a per channel 3 basis. This could be advantageous to maintain very short spatial resolution (0.5 m) over the inter array on a string basis (25 km) that would not be possible on the in-series length (75 km).

The pump gating does not have to be symmetric and could be adapted to match the actual length of each string, provided that it is possible to generate pump signals 5 with different time interval.

Compared to device 101, device 102 further comprises a probe generator 111 for generating the optical probe signal 8.

Probe generator 111 comprises typically a laser or a light-emitting diode.

However other kind of probe generator 111 may be employed within the scope of this disclosure.

The probe signal 8 typically:
is within 8 GHz and 12 GHz from the pump laser wavelength and can be scanned by a few kHz steps within this range and/or
has a power comprised between 0 and 100mW before being split by a probe splitter 10, 11, and/or
is a continuous probe signal 8.

Compared to device 101, device 102 further comprises an amplifier 9, in some implementations, an Erbium-Doped Fiber Amplifier (EDFA), arranged for amplifying the probe signal 8 before being the optical probe splitter 10, 11 described below.

Each channel 3 comprises an optical fiber 31 and/or:
connector 32 arranged for connecting, to gate 21 of this channel 3, a first end of the optical fiber 31 associated to this channel 3, and
probe connector 322 arranged for connecting, to gate 11 of this channel 3, a second end of the optical fiber 31 associated to this channel 3.

Connector 322 comprise a standard connector for optical fiber 31 according to prior art or other suitable connection means.

Compared to device 101, device 102 further comprises the optical probe splitter 10, 11 arranged for splitting the probe signal 8 in the N channels 3.

The optical probe splitter 10, 11 for splitting the probe signal 8 comprise:
an optical coupler 10, arranged for dividing the probe 8 from probe generator 111 and amplifier 9 into one probe 8 for each channel 3,
a gating system comprising a gate 11 for each channel 3 among the N channels 3, each gate 11 associated to a given channel 3 being arranged for having:
   ◯ an open state 218 allowing the probe signal 8 to go from the probe generator 111 for generating probe signal 8 to the optical fiber 31 or to the connector 322 of the associated channel 3, and
   ◯ a closed state for which the probe signal 8 cannot go from the probe generator 111 for generating signal 8 to the optical fiber 31 or to the connector 322 of the associated channel 3.

Each probe gate 11 could be home designed using:
a semi-conductor optical amplifier (SOA) and an electrical control signal, or
a shutter and an electrical control signal.

The controller (not illustrated) is configured (e.g., arranged and/or programmed) to keep the gate 11 of a given channel 3 in its open state 218 during all time signal 6 is acquired from this same channel 3 by optical receiver 4 and/or detector 44, while all the other gates 11 are in the closed state.

The gates 11 can be in the open state 218 only one by one.

The gates 21 and the gates 11 are respectively at two opposite ends of the fibers 31.

An embodiment of wind farm according to the disclosure comprises device 101 or 102.

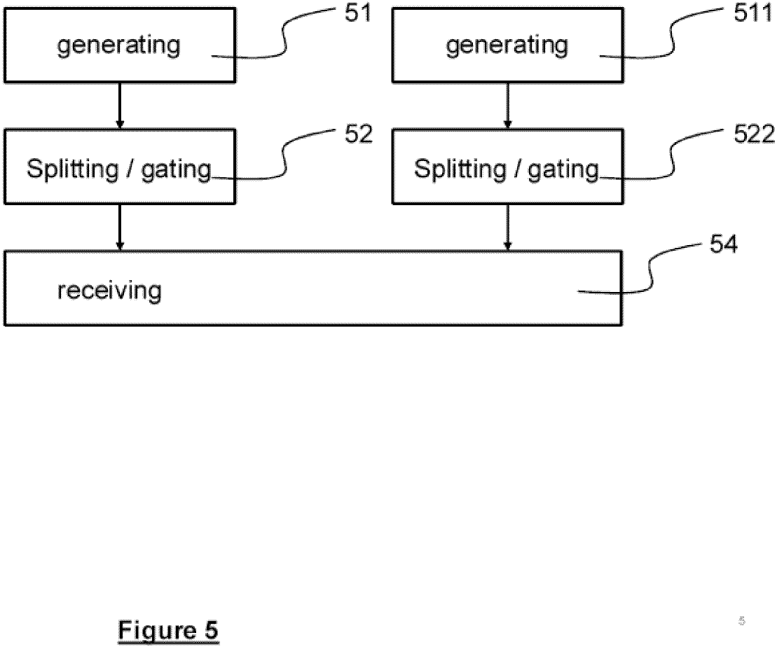

We are now going to describe, in reference to FIG. 5, steps of an embodiment of a method according to the disclosure implemented by device 101 or 102.

This method for distributed sensing comprises:
generating 51, by the pump generator 1, the pulsed optical pump signal 5,
splitting 52, by the optical pump splitter 2, the pump signal 5 in a number N of channels 3, and in some implementations, not in the N channels at the same time, each channel 3 comprising an optical fiber 31 or connector 32 arranged for connecting an optical fiber 31, the splitting step 52 avoiding injecting the pump signal 5 in at least two channels 3 at the same time, but optionally allowing at least two gates 21 to be in the open state 211 at the same time as long as they are not open at the same time when pulse 5 is reaching these at least two gates 21; the splitting step 52 being implemented with the gating system comprising the gate 21 for each channel 3 among the N channels, each gate 21 associated to a given channel 3 having:
   ◯ an open state 211 allowing the pump signal 5 to go from the pump generator 1 to the optical fiber 31 or to the connector 32 of the associated channel 3, and
   ◯ a closed state 210 for which the pump signal 5 cannot go from the pump generator 1 to the optical fiber 31 or to the connector 32 of the associated channel 3.
In some implementations, e.g., in case of device 102:
   ◯ Generating 511, by the probe generator 111, the probe signal 8,
   ◯ splitting 522, by the optical probe splitter 10, 11, the probe signal 8 in the N channels 3 (but not in the N channels at the same time), the splitting step 522 avoiding injecting the probe signal 8 in at least two channels 3 at the same time; the splitting step 522 being implemented with the gating system comprising the gate 11 for each channel 3 among the N channels. In this case, the pump signal 5 enters into a fiber 31 of a channel 3 only if, at the same time, the probe signal 8 enters into the same fiber 31 of the same channel 3. Gate 11 of a given channel 3 is in its open state 218 during all time signal 6 is acquired from this same channel 3 by optical receiver 4 and/or detector 44, while all the other gates 11 are in the closed state.
receiving 54, by optical receiver 4, a backscattered signal 6 from the optical fiber 31 or from the connector 32 of each channel 3 one channel 3 after the other, the optical receiver 4 comprising, for each channel 3, a circulator 41:
   ◯ directing the pump signal 5 from the gate 21 of this channel 3 in its open state 211 to the optical fiber 31 or to the connector 32 of this channel 3 but not to the optical receiver 4
   ◯ directing the backscattered signal 6 from the optical fiber 31 or from the connector 32 of this channel 3 to the optical receiver 4 but not to the gate 21 of this channel 3.

The optical fiber 31 of each channel 3 is monitoring:
at least one cable of a star network, in some implementations, monitoring an inter array cable of a star network of a wind farm, and/or
at least one cable of a pipeline network, a transport network such like a road or rail network, a telecommunication network, an information network, or an electrical network (in some implementations, a cable of a windfarm).

At least one channel 3 is monitoring several cables departing in several different directions from the central position of the star network, the optical fiber 31 of this at least one channel 3 going back and forth with respect to the central position.

Device 101 and/or 102 is, in some implementations, used for monitoring a wind farm.

Of course, the disclosure is not limited to the examples which have just been described and numerous amendments can be made to these examples without exceeding the scope of the disclosure.

For example, at least one fiber 31 or each fiber 31 can comprise a Fibre Bragg Grating (FBG). In this case, signal 5 is not necessary a pulsed signal 5 but can be a pulsed signal 5 or a continuous signal 5. Nevertheless, this embodiment is not a preferred embodiment, because if signal 5 is a continuous signal 5, then the gating is more complex, because the controller is then configured (e.g., arranged and/or programmed) in order to avoid at least two gates 21 to be in the open state 211 at the same time.

Of course, the different characteristics, forms, variants and embodiments of the disclosure can be combined with each other in various combinations to the extent that they are not incompatible or mutually exclusive. In particular, all variants and embodiments described above can be combined with each other.

1. A device for distributed sensing comprising:
a pump generator configured to generate an optical pump signal;
an optical pump splitter configured to receive the pump signal and split the pump signal in a number N of channels, each channel comprising an optical fiber or a connector arranged for connecting an optical fiber;
a controller configured to control the pump splitter;
an optical receiver configured to receive a backscattered signal from the optical fiber or from the connector of each channel, wherein:
the optical pump splitter comprises a gating system comprising a gate for each channel among the N channels, each gate associated to a given channel being configured to have:
an open state for which the pump signal is allowed to go from the pump generator to the optical fiber or the connector of the associated channel, and
a closed state for which the pump signal is not allowed to go from the pump generator to the optical fiber or the connector of the associated channel.

2. The device according to claim 1, wherein the pump signal is a pulsed pump signal, and the controller is configured to control that each gate is in its open state for a longer time than a duration of the pulsed pump signal in order to allow the pulsed pump signal to fully pass through the gate in its open state.

3. The device according to claim 1, wherein the controller is configured to avoid injecting the pump signal in at least two channels at the same time.

4. The device according to claim 1, wherein the optical receiver comprises, for each channel, a circulator, configured for:
directing the pump signal from the gate of this channel in its open state to the optical fiber or the connector of this channel but not to the optical receiver,
directing the backscattered signal from the optical fiber or the connector of this channel to the optical receiver but not to the gate of this channel.

5. The device according to claim 1, wherein the backscattered signal comprises one or more of a Rayleigh backscattered signal, a Brillouin backscattered signal, or a Raman backscattered signal.

6. The device according to claim 1, wherein each channel comprises an optical fiber configured to monitor one or more a cable, a pipe, a branch or a string of a star network.

7. The device according to claim 6, wherein at least one of the channels is configured for monitoring one or more of cables, pipes, branches or strings departing in several different directions from a central position of the star network, the optical fiber of the at least one channel going back and forth with respect to the central position.

8. The device according to claim 1, wherein each channel comprises an optical fiber configured to monitor at least one of a cable, a pipe, a branch or a string of at least one among a pipeline network, a transport network, a telecommunication network, an information network, or an electrical network.

9. The device according to claim 1, wherein the optical receiver comprises a detector shared for all the channels.

10. The device according to claim 1, wherein the controller is configured to control at least two gates to be in the open state at a same time.

11. A wind farm comprising a device according to claim 1.

12. A method for distributed sensing comprising:
generating, by a pump generator, an optical pump signal;
splitting, by an optical pump splitter, the optical pump signal in a number N of channels, each channel comprising an optical fiber or a connector arranged for connecting an optical fiber;
receiving, by an optical receiver, a backscattered signal from the optical fiber or from the connector of each channel, wherein:
the splitting is implemented with a gating system comprising a gate for each channel among the N channels, each gate associated to a channel of the N channels and having:
an open state for which the pump signal is allowed to go from the pump generator to the optical fiber or the connector of the associated channel, and
a closed state for which the pump signal is not allowed to go from the pump generator to the optical fiber or the connector of the associated channel.

13. The method according to claim 12, wherein the pump signal is a pulsed pump signal, and each gate is in its open state for a longer time than a duration of the pulsed pump signal in order to allow the pulsed pump signal to fully pass through the gate in its open state.

14. The method according to claim 12, wherein the splitting avoids injecting the pump signal in at least two channels at a same time.

15. The method according to claim 12, wherein the optical receiver comprises, for each channel, a circulator configured for:
directing the pump signal from the gate of the channel in its open state to the optical fiber or the connector of the channel but not to the optical receiver;
directing the backscattered signal from the optical fiber or the connector of the channel to the optical receiver but not to the gate of this channel.
